(19) United States
(12) Patent Application Publication
(10) Pub. No.: US 2014/0000907 A1
(43) Pub. Date: Jan. 2, 2014

(54) APPARATUS AND METHOD FOR BACKSEATING A GATE VALVE

(71) Applicants: Alfred Olvera, Houston, TX (US); Mahesha Udipi, Houston, TX (US); Mark A. Viator, Houston, TX (US); Jim Hwang, Houston, TX (US)

(72) Inventors: Alfred Olvera, Houston, TX (US); Mahesha Udipi, Houston, TX (US); Mark A. Viator, Houston, TX (US); Jim Hwang, Houston, TX (US)

(73) Assignee: VETCO GRAY INC., Houston, TX (US)

(21) Appl. No.: 13/536,432

(22) Filed: Jun. 28, 2012

(51) Int. Cl. E21B 34/08; E21B 34/06; F16K 41/00

(52) U.S. Cl. 166/373; 251/330; 251/329; 166/97.1

(57) ABSTRACT

A valve assembly for use in regulating a fracturing fluid that includes an actuating stem for actuating a gate, a balancing stem, and a backseat on the stem that defines a backseat seal when urged against a profile in the valve assembly. The backseat seal is energized by applying a force to an end of the balancing stem. An end of the balancing stem is enclosed within a plenum, so that the force on an end of the balancing stem can be applied by pressurizing the plenum. The assembly can be on an opposite side of the valve body/bonnet to create a backseat seal on a balancing stem/bonnet to allow changing the stem packing on the balance stem side while maintaining pressure integrity.

### BACKGROUND

1. Field of Invention

The invention relates generally to a valve assembly. More specifically, the invention relates to a method and device for backseating a gate valve assembly having a balanced stem by applying a force to a balanced stem.

2. Description of Prior Art

Fracturing subterranean formations adjacent to a well typically involves connecting an adapter to the upper end of a wellhead member and pumping high pressure liquid into the well. Isolating the pressure at designated locations in the well creates fractures in the formation. Beads or other proppant material is generally included in the fracturing fluid to enter the cracks to keep them open after the high pressure is removed. This type of operation is particularly useful for earth formations that have low permeability but adequate porosity and contain hydrocarbons, as the hydrocarbons can flow more easily through the fractures created in the earth formation.

The pressure employed during fracturing may be many times the natural earth formation pressure that ordinarily would exist. For example during fracturing, pressure in the wellhead can be 8,000 to 9,000 psi; whereas wellhead pressure might otherwise be at a few hundred to a few thousand psi. Because of this, valves employed for regulating the flow of fracturing fluid to a wellhead may require higher forces for their opening and closing. Sometimes, these high pressure valves may utilize balancing stems to compensate for pressure differentials that can impede valve operation.

Gate valves sometimes include a backseat feature for sealing between a valve stem and valve bonnet so that packing in the valve assembly can be changed. Backseats are typically made up of complimentary profiled surfaces in the stem and valve bonnet that when urged together isolate pressure communication along the stem. Backseats are generally energized by the pressure in the flow through the valve exerting a force on a bottom surface of the valve stem and urging together the profiled surfaces in the stem and bonnet.

### SUMMARY OF THE INVENTION

Provided herein is an example of a gate valve assembly that includes a body and a passage through the body. A source of fracturing fluid used for fracturing a subterranean formation communicates with the passage. Also included is a gate that can slide within the body and having a bore that selectively registers with the passage. An actuating stem is coupled to an end of the gate and projects into a channel in the body. A backseat seal is on an outer surface of the actuating stem that can selectively engage a profile in the channel. A balancing stem couples to an end of the gate distal from the actuating stem and a plenum is included that encloses an end of the balancing stem opposite from the gate valve, so that when the plenum is pressurized, a force is applied to the end of the balancing stem distal from the gate valve to urge the backseat seal into sealing engagement with the profile in the channel. A piston may optionally be included that is on the end of the balancing stem distal from the gate valve; where the piston has an outer periphery in sealing contact with an inner surface of the plenum. Optionally included is a pressure source in pressure communication with the plenum. In an example embodiment, the backseat seal projects radially outward from an outer surface of the actuating stem and has a wedge shaped cross section. The profile can have a shape that is complementary to the backseat seal and is defined where an inner diameter of the channel transitions radially inward. Optionally included is an upper bonnet having a chamber in which the end of the actuating stem coupled to the gate is disposed, and a lower bonnet having a chamber in which the end of the balancing stem coupled to the gate is disposed, wherein the chambers in the upper and lower bonnets are in pressure communication with the passage. An axial actuator may be included that is coupled to an end of the actuating stem distal from the gate for axially moving the stem.

Also provided herein is a method of regulating flow to a wellhead assembly. In one example embodiment the method includes providing a gate valve assembly that has a body, a gate moveable in the body, an actuating stem coupled to an end of the gate, a backseat seal on the actuating stem, and a balancing stem coupled to an end of the gate distal from the actuating stem. Fluid is communicated to the gate valve assembly so that pressure in the fluid is applied to ends of the actuating stem and balancing stem coupled to the gate and generates substantially equal forces that are applied to the gate in opposite directions. A force is applied to urge the balancing stem against the gate in a direction that displaces the actuating stem so that the backseat seal engages a profile in the body to form a seal around a portion of the actuating stem. Optionally, the step of forcing the balancing stem includes pressurizing an area around an end of the balancing stem distal from the gate. In one example, the area is pressurized by providing a plenum around the end of the balancing stem distal from the gate and flowing pressurized fluid to the plenum. Alternatively, packing is provided in an annulus between the actuating stem and the body that is isolated from pressure of the fluid by the backseat seal. In another example, the applied force is removed.

An example of a wellhead assembly mounted over a wellbore is described herein that includes a production tree, a valve block on the production tree in fluid communication with a source of fracturing fluid, and a valve assembly on the valve block. The valve assembly is made up of a valve body having a passage in fluid communication with the fracturing fluid, a gate in the body, an actuating stem having a lower end that is mounted on an upper end of the gate and that is in pressure communication with the passage, a backseat seal circumscribing a portion of the actuating stem, a balancing stem having an upper end mounted on a lower end of the gate and that is in pressure communication with the passage, and a means for selectively forcing the balancing stem upward and against the gate and to seat the backseat seal against a profile in the body to form a seal. Optionally, the means for selectively forcing the balancing stem upward includes a plenum mounted on a lower end of the valve body that is in communication with a source of pressurized fluid. Alternatively, the plenum has an inner diameter sized to be in selective sealing contact with an outer surface of the balancing stem. In one example, a piston on a lower end of the balancing stem is included. In an example embodiment, included is a hand wheel on the valve assembly for moving the gate.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side partial sectional view of an example embodiment of a wellhead assembly having a frac valve assembly in accordance with the present invention.

FIG. 2 is a side sectional view of an example of a frac valve assembly of FIG. 1 and having a backseating feature in accordance with the present disclosure.

FIG. 3 is a side partial sectional view of an embodiment of a portion of the frac valve assembly of FIG. 2 in accordance with the present invention.

FIGS. 4A and 4B are side sectional views of a backseat seal being formed along a stem of the frac valve assembly of FIG. 2 in accordance with the present invention.

FIGS. 5 and 6 are a side partial sectional views of alternate embodiments of a portion of the frac valve assembly of FIG. 2 in accordance with the present invention.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation. Accordingly, the improvements herein described are therefore to be limited only by the scope of the appended claims.

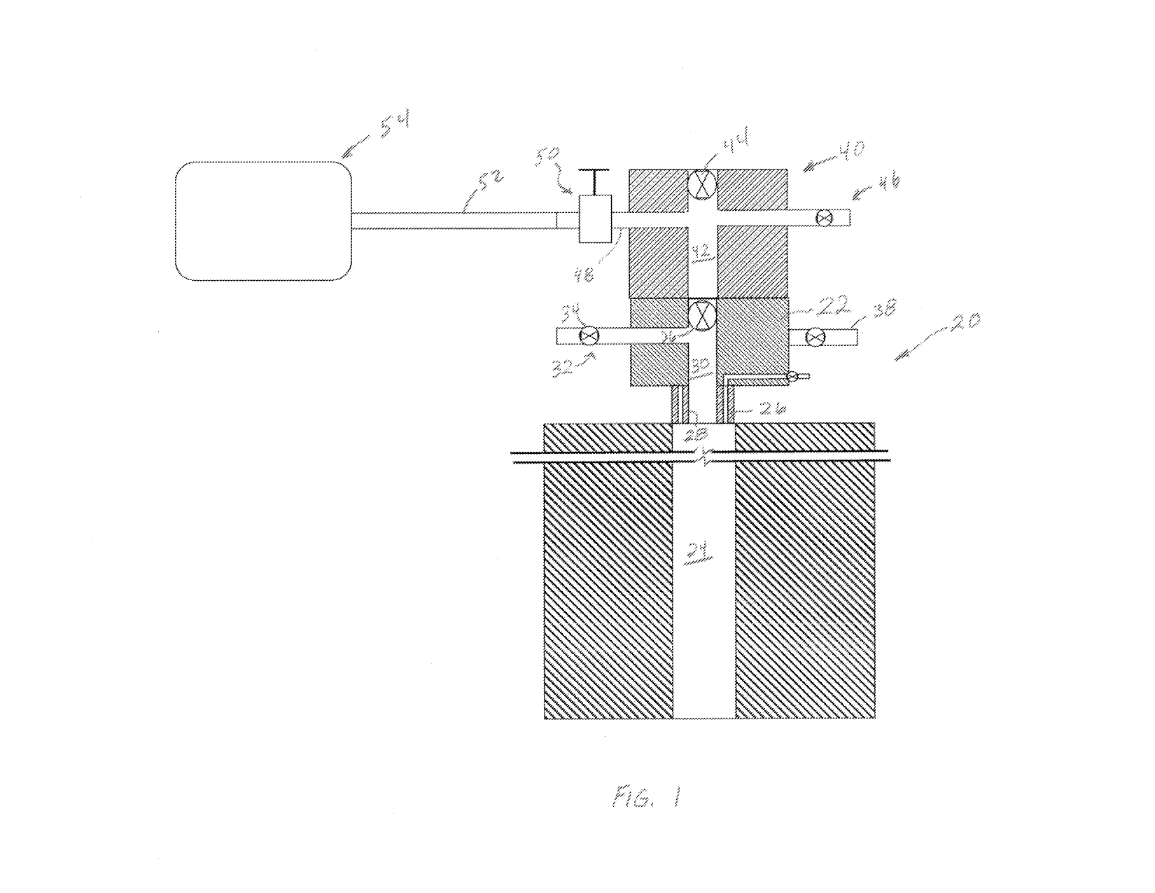

Shown in FIG. 1 is an example of a wellhead assembly 20 illustrated in a side partial sectional view where the wellhead assembly 20 includes a production tree 22 mounted over a wellbore 24. The wellhead assembly 20 includes a wellhead housing 26 shown depending downward from the production tree 22 into the wellbore 24 and in which a string of casing 28 is coaxially disposed therein. The production tree 22 includes an axial main bore 30 shown intersected by a production line 32 that extends laterally through the production tree 22. A wing valve 34 is in the production line 32 and provided for controlling flow through the production line 32, and a swab valve 36 is shown set in an upper end of the main bore 30. An auxiliary line 38 may optionally be included onto the production tree 22.

An example embodiment of a valve block 40 is shown set on an upper end of the production tree 22. A bore 42 axially traverses the valve block 40 and has a lower end in fluid communication with the upper end of the main bore 30. Optionally, an access valve 44 is provided in an upper end of the bore 42. Also optionally, is an auxiliary line 46 that intersects the bore 42 and shown having a portion projecting outward past an edge of the body of the valve block 40. On a side opposite the auxiliary line 46 is an inlet line 48 that also extends laterally through the valve block 40 and intersects the bore 42. A valve assembly 50 is shown set in the inlet line 48, and in the example of FIG. 1, can be used for regulating fluids, such as a fracturing fluid, that are designated for entry into the valve block 40. A flow line 52 connects to an upstream side of the valve assembly 50, where the flow line 52 delivers fluid from a fluid supply 54 to the valve assembly 50. As indicated above, fracturing fluid may be delivered through the line 52, and as such, one example of the fluid supply 54 can be a series of high pressure pumps for pressurizing fracturing fluid.

In FIG. 2 is an example embodiment of the valve assembly 50 and is shown in a side sectional view. The valve assembly 50 of FIG. 2 includes a valve body 56 that is shown intersected by a passage 58 that extends laterally through the width of the body 56. A gate 60 is shown axially disposed within the body 56 and having a portion set within the passage 58. The gate 60 includes a bore 62 laterally oriented and shown registered with the passage 58. By axially traversing the gate 60 within the body 56, flow through the passage 58 may be regulated through the valve assembly 50. An actuating stem 64 is shown coupled onto an upper end of the gate 60 and is used to transmit a force for vertical movement of the gate 60 within the body 56.

A threaded rod 66 is shown set on an upper end of the actuating stem 64 and is circumscribed by a sleeve 68. The sleeve 68 is mounted into a hand wheel 70 and rotatable by rotation of the hand wheel 70. Threads are provided on an inner surface of the sleeve 68 that engage threads on an outer surface of the threaded rod 66. The sleeve 68 is shown mounted within a housing 72 and is rotatable with respect to the housing 72. The housing 72 is a generally annular member coupled on an upper end of the valve body 56. Although rotatable, the sleeve 68 is not vertically moveable with respect to the housing 72. A bearing assembly 74 shown set in an annular space between the sleeve 68 and stem housing 72 provides a reduction of friction, thereby allowing ease of movement of the sleeve 68 to reduce frictional forces associated with actuation of the gate 60.

As is known, pressure within the passage 58 can migrate past the face of the gate 60 and onto a lower-most surface of the actuating stem 64. This results in an upward force on the actuating stem 64 that resists downward movement of the gate 60. To compensate for the upward force, a balancing stem 76 is shown coupled on a lower end of the gate 60. The upper end of the balancing stem 76, which is shown having a substantially same cross-sectional area as the actuating stem 64, is also in pressure communication with the passage 58. Thus, a downward force is exerted on the upper end of the balancing stem 76 that transfers to the gate 60 and cancels the upward force on the actuating stem 64. The valve assembly 50 includes an upper bonnet 78 that is shown mounted on an upper end of the valve body 56. An opening within the bonnet 78 defines a chamber 79 in which is an upper end of the gate 60. The chamber 79 has a pressure substantially the same as that of the passage 58. As will be described in more detail below, backseating functions can be compromised by introduction of a balancing stem.

Still referring to FIG. 2, a balancing stem plenum 80 is shown mounted onto a neck portion 81 of a lower bonnet 82. The lower bonnet 82, which is substantially the same as the upper bonnet 78, mounts on a lower end of the valve body 56. In the example of FIG. 2, the plenum 80 is a tubular-shaped member having an upper end configured for attachment onto the neck 81. The plenum 80 is open on its upper end and substantially closed on its lower end. Optionally, provided with the valve assembly 50 is a valve stand 84 that is made up of a disc-like base 86 that is set in a plane transverse to an axis of the balancing stem 76. Wedge-shaped legs 88 have lower ends that mount on an upper side of the base 86 and are arranged to have edges parallel to an axis of the balancing stem 76. The edges of the legs 88 are set apart so that a tubular-like sleeve 90 can be inserted in between the legs 88. A flange on an upper end of the sleeve 90 projects radially outward, thereby forming a lip for supporting the sleeve 90 within the legs 88. In the example of FIG. 2, the plenum 80 is shown inserted within the sleeve 90.

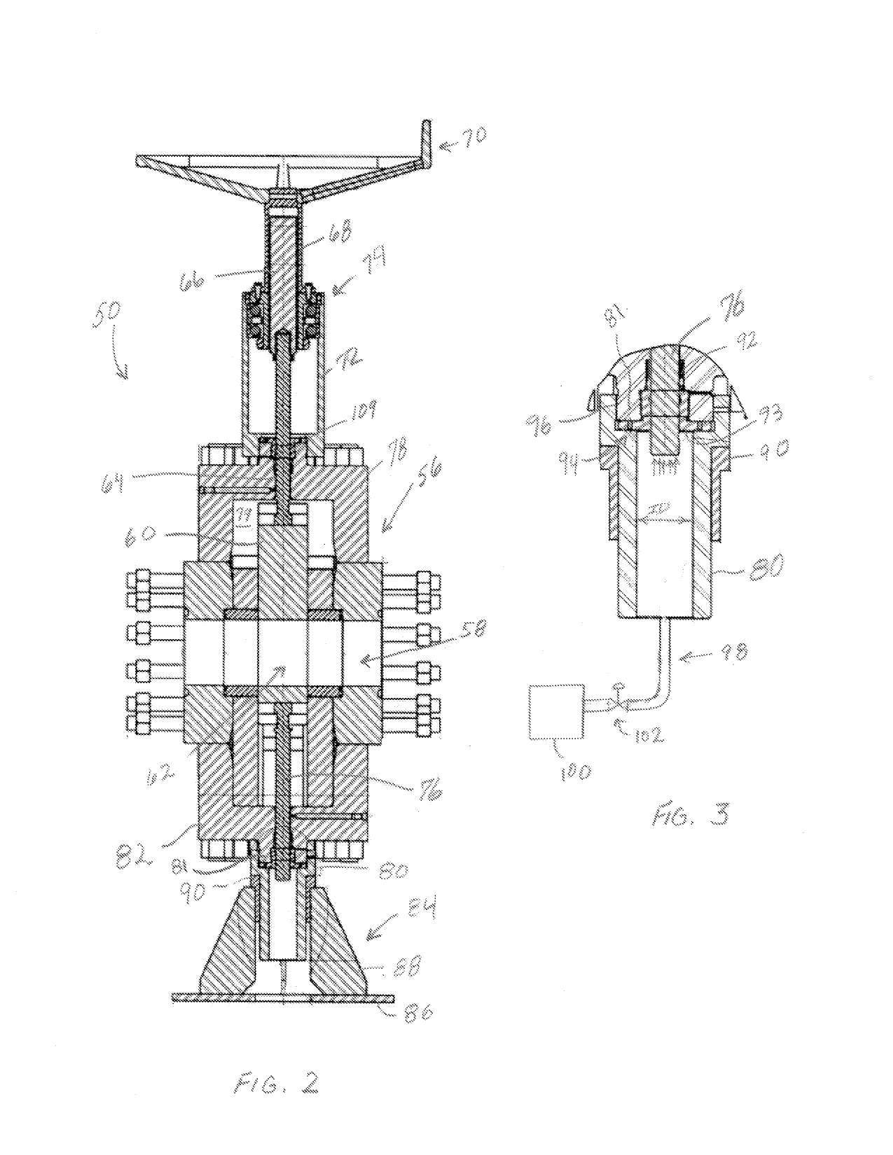

Referring now to FIG. 3, a side partial sectional view of a detail of the plenum 80 is shown. In the example of FIG. 3, a gland packing 92 is provided in an annulus between the neck 81 and balancing stem 76. The packing 92 is retained in place by a packing collar 93 that has an outer diameter close to an outer diameter of the neck 81. Radially inward from its outer periphery, the collar 93 projects axially upward and in a direction substantially normal from its outer portion. The axial projecting section of the collar 93 is shown contacting a lower end of the packing 92. Still referring to FIG. 3, the plenum 80 has an open upper end and side walls that project radially outward proximate to its upper end, thereby defining a radial ledge 94 that is shown set up against a lower surface of the packing collar 93. Upward and past the radial ledge 94, side walls of the plenum 80 extend axially upward and circumscribe an outer surface of the neck 81. Threads 96 are formed on an inner surface of the upper end of the plenum 80 and outer surface of the neck 81 that allow for coupling of the plenum 80 onto the bonnet 82.

Further illustrated in FIG. 3 is that the open inner space of the plenum can be pressurized via connection to a line 98 for delivering pressurized fluid from a pressure source 100 into the plenum 80. A valve 102 is optionally shown for regulating flow of fluid through the line 98. As indicated by the arrows directed against a lower end of the balancing stem 76, the presence of pressurized fluid within the plenum 81 exerts an upward force on the balancing stem 76 to urge it against the gate 60.

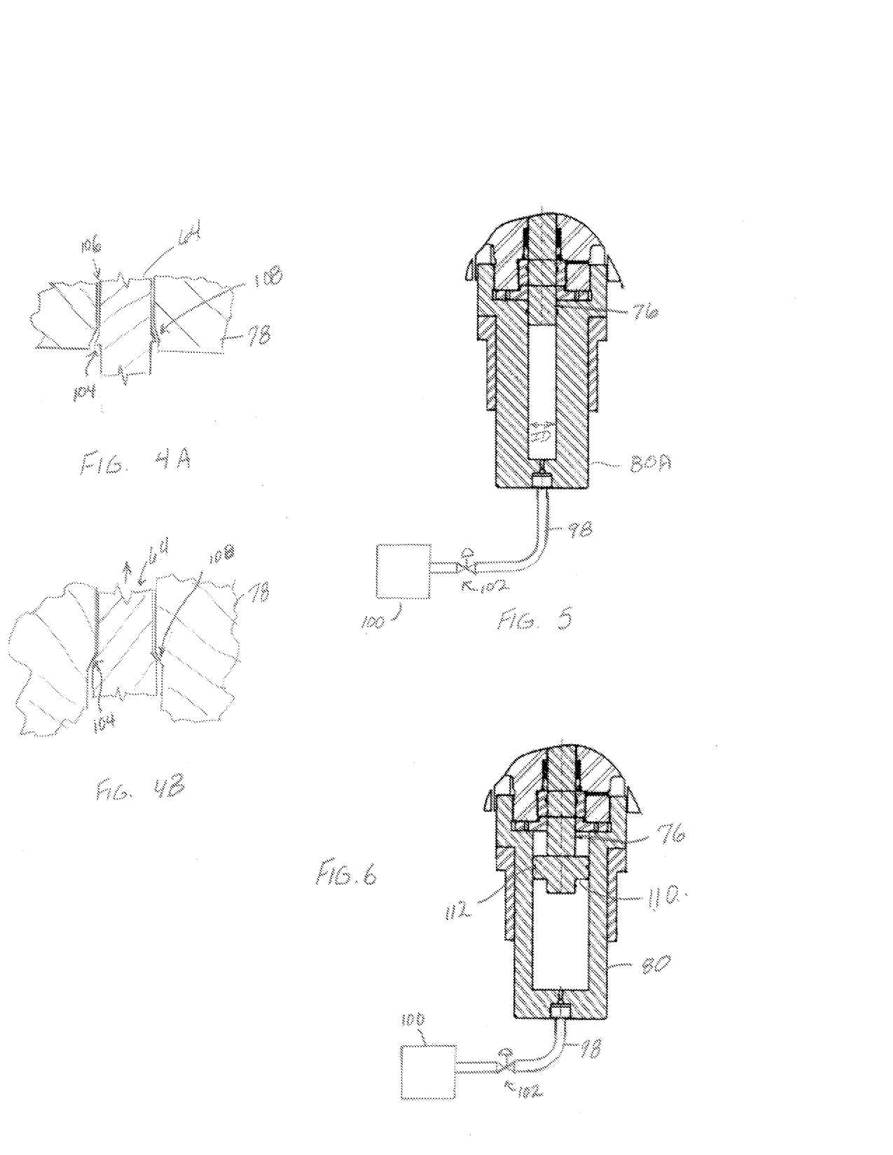

FIG. 4A illustrates in a side sectional view an example of how the upward force applied to the balancing stem 76 can counteract its compensating force to overcome backseating issues. More specifically, a backseat 104 is shown set on an outer periphery of the actuating stem 64 and in a location proximate where the actuating stem 64 projects through a bore 106 formed through the bonnet 78. In the example of FIG. 4A, the backseat 104 has a triangular-shaped cross-section and has an increasing radius with distance towards the gate 60. In one example, the backseat 104 is referred to as a backseat seal. Also shown in FIG. 4A is a profile 108 that is formed in the bonnet 78 and at an opening of the bore 106. FIG. 4B illustrates an example where a backseat seal is formed, thereby isolating pressure above the bonnet 78 from the chamber 79. More specifically, the actuating stem 64 has moved upward in the direction of the arrow so that the backseat 104 has sealingly engaged the profile 108, thereby forming a pressure barrier axially along the stem 64. As such, by forming a backseating procedure, any packing 109 (FIG. 2) set within the annulus between the actuating stem 64 and bonnet 78, above the backseat 104, may be accessed and replaced without exposing personnel to the pressures within the passage 58.

FIG. 5 illustrates an alternate embodiment of a plenum 80A, wherein the plenum has an internal diameter (ID) substantially the same as an outer diameter of the balancing stem 76. As such, sealing contact may take place between the balancing stem 76 and inner diameter of the annulus 80A. Thus, when pressurizing fluid from the source 100 and through the line 98 enters within the plenum 80A, a smaller amount of fluid may be required in order to move the balancing stem 76 upward. Referring now to FIG. 6, yet another example embodiment of the plenum 80 is illustrated, wherein a piston 110 is shown set within the plenum 80 and having an upward end in contact with a lower end of the balancing stem 76. Optional O-ring seals 112 may be provided on an outer periphery of the piston 110 to provide a seal between the piston 110 and inner surfaces of the plenum 80.

In one example of operation, fluid from the fluid supply 54 is being delivered to the wellhead assembly 20. Over a period of time, the packing 109 may require replacement and to safely provide access to within the stem housing 72, the actuating stem 64 is urged upward so that the backseat 104 is in sealing engagement with the profile 108 (FIG. 4B). During this time, the packing 109 can be accessed and pressure within the passage 58 is isolated from above the backseat 104, although pressure in the chamber 79 may remain substantially the same as that of the passage 58. After successfully replacing the packing 109 the force provided on the lower end of the balancing stem 76 can be removed, thereby disengaging the backseat 104 from the profile 108.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A gate valve assembly comprising:
a body;
a passage through the body that is selectively coupled with a source of fracturing fluid used for fracturing a subterranean formation;
a gate slideable in the body, and having a bore that selectively registers with the passage;
an actuating stem coupled to an end of the gate and that projects into a channel in the body;
a backseat seal on an outer surface of the actuating stem that is in selective engagement with a profile in the channel;
a balancing stem coupled to an end of the gate distal from the actuating stem; and
a plenum enclosing an end of the balancing stem distal from the gate valve, so that when the plenum is pressurized, a force is applied to the end of the balancing stem distal from the gate valve to urge the backseat seal into sealing engagement with the profile in the channel.

2. The gate valve assembly of claim 1, further comprising a piston on the end of the balancing stem distal from the gate valve and having an outer periphery in sealing contact with an inner surface of the plenum.

3. The gate valve assembly of claim 1, wherein a pressure source is in pressure communication with the plenum.

4. The gate valve assembly of claim 1, wherein the backseat seal projects radially outward from an outer surface of the actuating stem and has a wedge shaped cross section.

5. The gate valve assembly of claim 4, wherein the profile has a shape that is complementary to the backseat seal and is defined where an inner diameter of the channel transitions radially inward.

6. The gate valve assembly of claim 1, further comprising an upper bonnet having a chamber in which the end of the actuating stem coupled to the gate is disposed, and a lower bonnet a chamber in which the end of the balancing stem coupled to the gate is disposed, wherein the chambers in the upper and lower bonnets are in pressure communication with the passage.

7. The gate valve assembly of claim 1, further comprising an axial actuator coupled to an end of the actuating stem distal from the gate for axially moving the stem.

8. A method of regulating flow to a wellhead assembly comprising:
a. providing a gate valve assembly having a body, a gate moveable in the body, an actuating stem coupled to an end of the gate, a backseat seal on the actuating stem, and a balancing stem coupled to an end of the gate distal from the actuating stem;
b. communicating fluid to the gate valve assembly so that pressure in the fluid is applied to ends of the actuating stem and balancing stem coupled to the gate and generates substantially equal forces that are applied to the gate in opposite directions; and
c. applying a force to urge the balancing stem against the gate in a direction that displaces the actuating stem so that the backseat seal engages a profile in the body to form a seal around a portion of the actuating stem.

9. The method of claim 8, wherein the step of forcing the balancing stem comprises pressurizing an area around an end of the balancing stem distal from the gate.

10. The method of claim 9, wherein the area is pressurized by providing a plenum around the end of the balancing stem distal from the gate and flowing pressurized fluid to the plenum.

11. The method of claim 8, further comprising replacing packing in an annulus between the actuating stem and the body that is isolated from pressure of the fluid of step (b) by the backseat seal.

12. The method of claim 8, further comprising removing the force of step (c).

13. A wellhead assembly mounted over a wellbore comprising:
a production tree;
a valve block on the production tree in fluid communication with a source of fracturing fluid; and
a valve assembly on the valve block comprising:
a valve body having a passage in fluid communication with the fracturing fluid, a gate in the body,
an actuating stem having a lower end that is mounted on an upper end of the gate and that is in pressure communication with the passage,
a backseat seal circumscribing a portion of the actuating stem,
a balancing stem having an upper end mounted on a lower end of the gate and that is in pressure communication with the passage, and
a means for selectively forcing the balancing stem upward and against the gate and to seat the backseat seal against a profile in the body to form a seal.

14. The wellhead assembly of claim 13, wherein the means for selectively forcing the balancing stem upward comprises a plenum mounted on a lower end of the valve body that is in communication with a source of pressurized fluid.

15. The wellhead assembly of claim 14, wherein the plenum has an inner diameter sized to be in selective sealing contact with an outer surface of the balancing stem.

16. The wellhead assembly of claim 14, further comprising a piston on a lower end of the balancing stem.

17. The wellhead assembly of claim 14, further comprising a hand wheel on the valve assembly for moving the gate.
